(19) United States
(12) Patent Application Publication
(10) Pub. No.: US 2008/0128000 A1
(43) Pub. Date: Jun. 5, 2008

(54) Washing control apparatus and method of dish washing machine

(75) Inventors: Shimotera Kennichi, Seoul (KR); Sang Soo Choi, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/896,642

(22) Filed: Sep. 4, 2007

(30) Foreign Application Priority Data
Dec. 4, 2006 (KR) 10-2006-0121632

(51) Int. Cl. B08B 3/02

(52) U.S. Cl. 134/18; 134/57 D

(57) ABSTRACT

A washing control apparatus and method of a dish washing machine capable of detecting the turbidity of wash water during washing to determine a next washing operation. The washing control method includes detecting a turbidity of wash water while performing washing using the wash water, and determining a washing operation to be performed based on the detected turbidity of the wash water.

### CROSS-REFERENCE TO RELATED APPLICATIONS

This application claims the benefit of Korean Patent Application No. 10-2006-0121632, filed on Dec. 4, 2006 in the Korean Intellectual Property Office, the disclosure of which is incorporated herein by reference.

### BACKGROUND

1. Field

The present invention relates to washing control of a dish washing machine. More particularly, to a washing control apparatus and method of a dish washing machine capable of detecting the turbidity of wash water during washing to determine a next washing operation.

2. Description of the Related Art

A conventional dish washing machine washes food leftovers (hereinafter, referred to as “contaminants”) off dishes using cold wash water or hot wash water. The conventional dish washing machine includes a machine body having a washing tub, dish baskets mounted in the washing tub, injection nozzles to inject wash water to dish baskets, and a sump connected to the injection nozzles to pump wash water into the injection nozzles.

When wash water is introduced into the dish washing machine while dishes to be washed are placed in the dish baskets, the dish washing machine washes the dishes through washing and rinsing operations in which a washing pump mounted at the sump is operated to forward wash water to the injection nozzles and the wash water is injected to dishes through the injection nozzles at high pressure. The washing and rinsing operations include a preliminary operation (preliminary washing or preliminary rinsing) and a main operation (main washing or final rinsing). The preliminary operation may be performed a predetermined number of times (normally, twice) before the main operation.

Although the dishes can be completely washed by performing the preliminary operation (preliminary washing or preliminary rinsing) only once when the dishes are not excessively contaminated, however, the dish washing machine unconditionally performs the preliminary operation (preliminary washing or preliminary rinsing) a predetermined number of times. As a result, water consumption increases, and power consumption also increases.

### SUMMARY

Accordingly, it is an aspect of the present invention to provide a washing control apparatus and method of a dish washing machine capable of detecting the turbidity of wash water during washing, to thereby determine a next washing operation, thereby reducing the number of washing times and thus preventing waste of wash water.

It is another aspect of the present invention to provide a washing control apparatus and method of a dish washing machine capable of detecting the turbidity of wash water before drainage of a previous washing operation and the turbidity of wash water after the initiation of a next washing operation twice, to thereby determine kinds of contamination, thereby accomplishing an appropriate washing process irrespective of kinds of contamination.

It is a further aspect of the present invention to provide a washing control apparatus and method of a dish washing machine capable of changing a load action of a next washing operation based on the turbidity of wash water detected before drainage of a previous washing operation and the turbidity of wash water detected after the initiation of a next washing operation, thereby appropriately controlling washing time.

Additional aspects and/or advantages will be set forth in part in the description which follows and, in part, will be apparent from the description, or may be learned by practice of the invention.

The foregoing and/or other aspects of the present invention are achieved by providing a washing control method of a dish washing machine including detecting a turbidity of wash water while performing washing using the wash water, and determining a washing operation to be performed, based on the detected turbidity of the wash water.

According to an aspect of the present invention, detecting the turbidity of the wash water includes detecting a turbidity of wash water before drainage of a previous washing operation and a turbidity of wash water after the initiation of a next washing operation.

According to an aspect of the present invention, the turbidity of the wash water after the initiation of the next washing operation is a turbidity of wash water after the performance of the next washing operation for a predetermined period of time after water supply for the next washing operation.

According to an aspect of the present invention, the previous washing operation is a first preliminary washing of the dish washing machine, and the next washing operation is a second preliminary washing of the dish washing machine.

According to an aspect of the present invention, the previous washing operation is a main washing of the dish washing machine, and the next washing operation is a preliminary rinsing of the dish washing machine.

According to an aspect of the present invention, determining the washing operation to be performed includes comparing the detected turbidity of the wash water with a predetermined reference turbidity, and when the detected turbidity of the wash water does not exceed the reference turbidity, omitting at least one washing operation from a predetermined series of washing operations, and the omitting the at least one washing operation includes omitting a preliminary washing or a preliminary rinsing of the dish washing machine.

According to an aspect of the present invention, the washing operation further includes changing the washing operation in progress into a subsequent operation when the detected turbidity of the wash water does not exceed the predetermined reference turbidity, and the changing the washing operation in progress into the subsequent operation includes changing the second preliminary washing in progress into a main washing.

According to an aspect of the present invention, determining the washing operation to be performed further includes, completely performing the predetermined series of washing operations when the detected turbidity of the wash water exceeds the predetermined reference turbidity.

It is another aspect of the present invention to provide a washing control apparatus of a dish washing machine including a turbidity detection unit to detect a turbidity of wash water while washing is performed using the wash water, and a control unit to determine a washing operation based on the detected turbidity of the wash water.

According to an aspect of the present invention, the turbidity detection unit detects a turbidity of wash water before drainage of a previous washing operation and a turbidity of wash water after the initiation of a next washing operation.

According to an aspect of the present invention, the control unit compares the detected turbidity of the wash water with a predetermined reference turbidity, and omits a preliminary washing or a preliminary rinsing from a predetermined series of washing operations when the detected turbidity of the wash water does not exceed the predetermined reference turbidity.

According to an aspect of the present invention the control unit changes a second preliminary washing in progress into a main washing when the detected turbidity of the wash water does not exceed the predetermined reference turbidity.

According to an aspect of the present invention the control unit completely performs the predetermined series of washing operations when the detected turbidity of the wash water exceeds the predetermined turbidity.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side sectional view illustrating the structure of a dish washing machine according to an embodiment of the present invention;

FIG. 2 is a control block diagram of a dish washing machine according to an embodiment of the present invention; and

FIGS. 3A-3C are flow charts illustrating a washing control method of a dish washing machine according to an embodiment of the present invention.

### DETAILED DESCRIPTION OF THE EMBODIMENTS

Reference will now be made in detail to the embodiment of the present invention, examples of which are illustrated in the accompanying drawings, wherein like reference numerals refer to like elements throughout. The embodiments are described below to explain the present invention by referring to the figures.

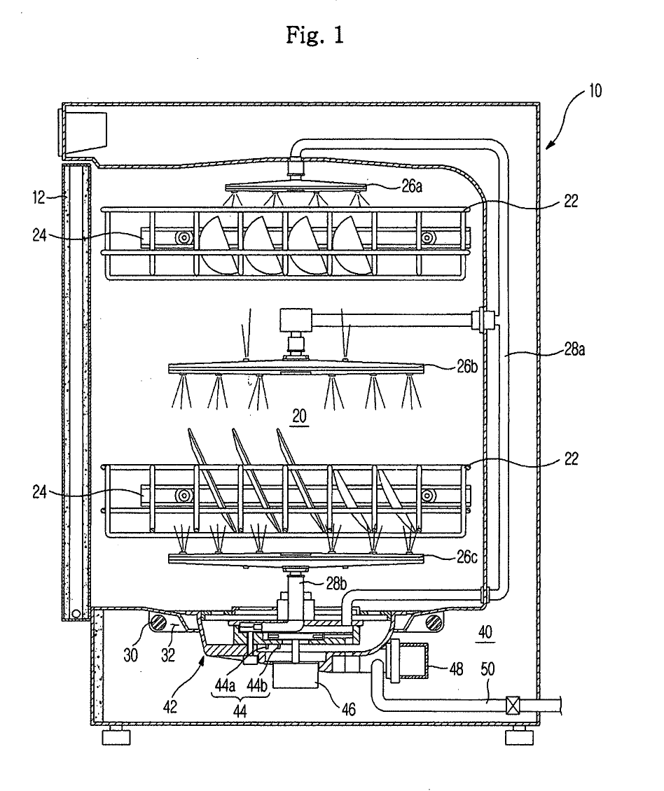

FIG. 1 is a side sectional view illustrating the structure of a dish washing machine according to an embodiment of the present invention.

As shown in FIG. 1, the dish washing machine comprises a machine body 10 having a washing space defined therein, and a door 12 to open and close the front part of the machine body 10. The machine body 10 and the door 12 constitute the appearance of the dish washing machine.

A washing tub 20 is mounted in the machine body 10 and comprises a plurality of dish baskets 22 to receive dishes, racks 24 to slidably support the dish baskets 22, an upper injection nozzle 26a, a middle injection nozzle 26b, and a lower injection nozzle 26c. Specifically, the upper injection nozzle 26a, the middle injection nozzle 26b, and the lower injection nozzle 26c are mounted above and below the dish baskets 22 to inject wash water.

The upper injection nozzle 26a and the middle injection nozzle 26b are connected to a sump 42, which will be described below, via a first supply pipe 28a. The lower injection nozzle 26c is connected to the sump 42 via a second supply pipe 28b.

A heater 30 to heat wash water is mounted at the bottom of the washing tub 20. Specifically, the heater 30 is disposed in a heater receiving groove 32 formed at the bottom of the washing tub 20.

A machine compartment 40 is also mounted at the bottom of the washing tub 20, in which the sump 42, which pumps wash water introduced into the washing water 20 to forward the wash water to the upper, middle, and lower injection nozzles 26a, 26b, and 26c, is mounted. A turbidity sensor 44 is mounted in the sump 42, to detect the turbidity of water used to wash the dishes (i.e., the contamination level of wash water) during a washing operation.

The turbidity sensor 44 detects the turbidity of wash water using a photo coupler sensing light emitted from a light emitting part 44a, transmitted through wash water used to wash the dishes, and received by a light receiving part 44b.

The sump 42 includes various flow channels. A washing pump 46 to pump water to the flow channels is also mounted at the sump 42. Further, a drainage pump 48 and a drainage pipe 50 to drain contaminated wash water to the outside are mounted at one side of the sump 42.

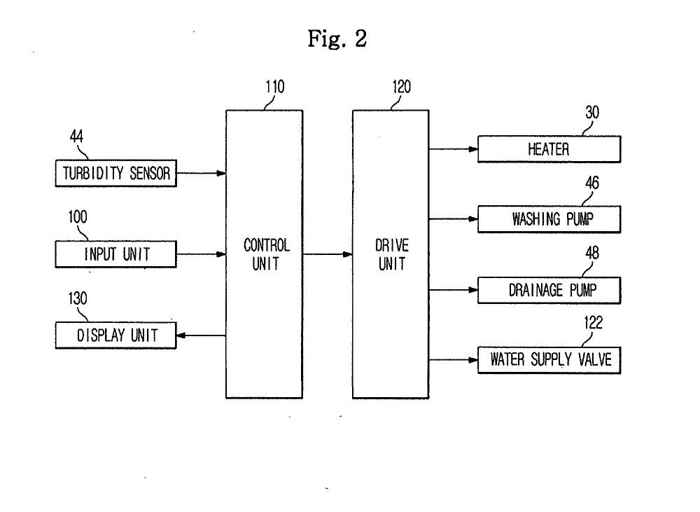

FIG. 2 is a control block diagram of a dish washing machine according to an embodiment of the present invention. In addition to the components shown in FIG. 1, the dish washing machine further comprises an input unit 100, a control unit 110, a drive unit 120, and a display unit 130.

The input unit 100 allows a user to input operation information such as a washing course, a wash water temperature, and addition of rinsing to the control unit 110.

The control unit 110 is a microcomputer which controls the dish washing machine according to the operation information inputted from the input unit 100. The control unit 110 detects the turbidity V1 of wash water before drainage of a previous preliminary washing (i.e., preliminary washing 1) and the turbidity V2 of wash water after water supply for a next preliminary washing (i.e., preliminary washing 2) (to be exact, after the performance of the next preliminary washing for a predetermined period of time after water supply) twice. When the detected turbidities V1 and V2 of the wash water exceed a predetermined reference turbidity Va, the control unit 110 determines that the contamination of the wash water is excessive, and completely performs the second preliminary washing (i.e., preliminary washing 2). When the detected turbidities V1 and V2 of the wash water do not exceed the reference turbidity Va, the control unit 110 changes the second preliminary washing (i.e., preliminary washing 2) into a main washing.

Also, the control unit 110 detects the turbidity V3 of wash water before drainage of the main washing and the turbidity V4 of wash water after water supply for a next preliminary rinsing (i.e., preliminary rinsing 1) (to be exact, after the performance of the next preliminary rinsing for a predetermined period of time after water supply) twice. When the detected turbidities V3 and V4 of the wash water exceed a predetermined reference turbidity Vb, the control unit 110 determines that the contamination of the wash water is excessive, and completely performs a second preliminary rinsing (i.e., preliminary rinsing 2). When the detected turbidities V3 and V4 of the wash water do not exceed the reference turbidity Vb, the control unit 110 omits the second preliminary rinsing (i.e., preliminary rinsing 2).

Also, when the control unit 110 changes the second preliminary washing (i.e., preliminary washing 2) into the main washing or omits the second preliminary rinsing (i.e., preliminary rinsing 2), the control unit 110 appropriately controls wash water temperature, detergent supply, and washing time.

The drive unit 120 drives the heater 30, the washing pump 46, the drainage pump 48, and a water supply valve 122 according to a drive control signal of the control unit 110. The water supply valve 122 controls the supply of wash water into the washing tub 20.

The display unit 130 displays the operation state and error of the dish washing machine according to a display control signal of the control unit 110.

Hereinafter, a washing control method of the dish washing machine with the above-stated construction will be described in detail.

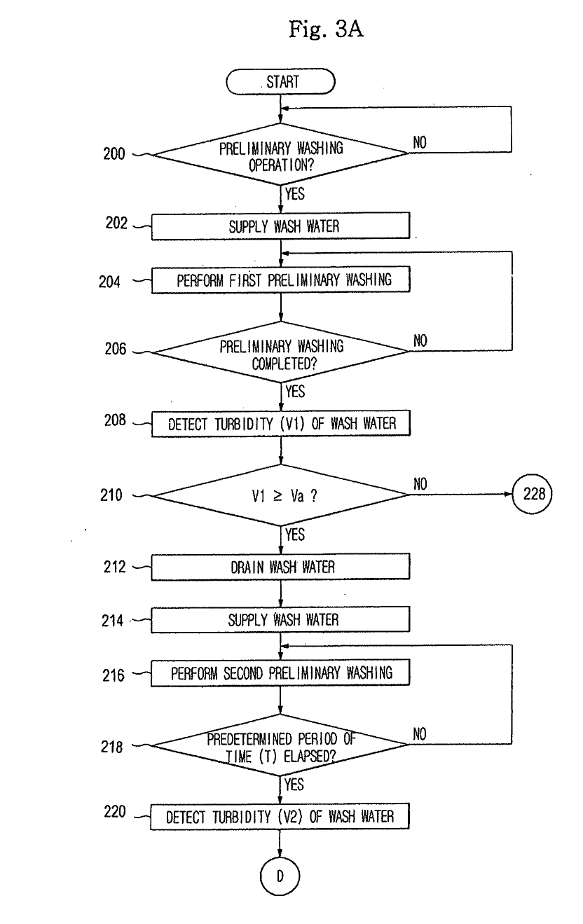

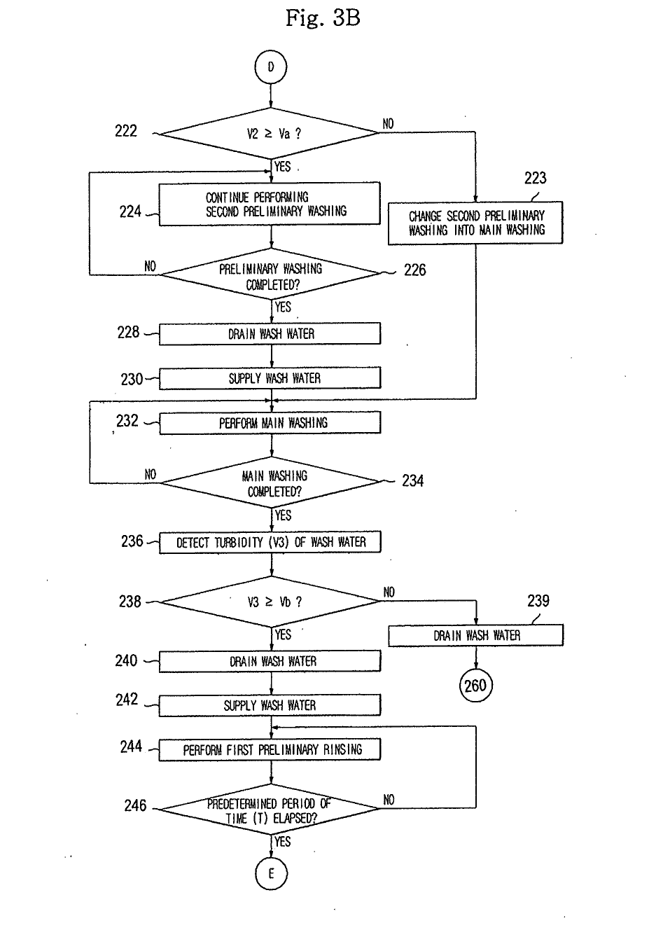

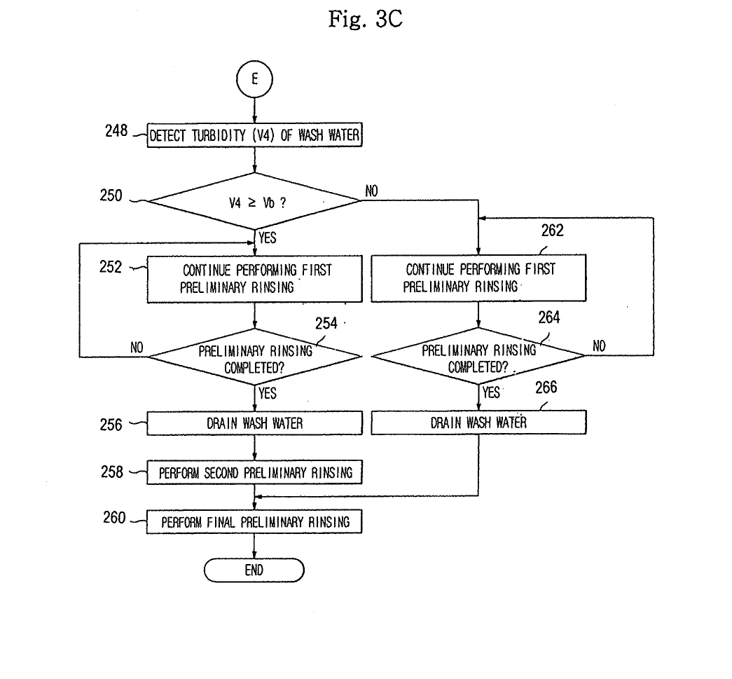

FIGS. 3A-3C are flow charts illustrating a washing control method of the dish washing machine according to an embodiment of the present invention.

When a user selects operation information such as a washing course, wash water temperature, and addition of rinsing while dishes to be washed are placed in the dish baskets 22 mounted in the washing tub 20, the operation information selected by the user is inputted to the control unit 110 through the input unit 100.

The control unit 110 performs a series of washing processes such as a washing operation, a rinsing operation, and a drying operation according to the operation information inputted from the input unit 100. First, in operation 200, the control unit 110 determines whether the operation is a preliminary washing operation.

When the operation is the preliminary washing operation, the control unit 110 controls the water supply valve 122 through the drive unit 120. Consequently, in operation 202, wash water necessary for the preliminary washing is supplied into the washing tube 20 through wash water supply holes (not shown).

The wash water supplied into the washing tub 20 is introduced into the sump 42 mounted at the bottom of the washing tub 20. The introduced wash water is forwarded to the upper injection nozzle 26a, the middle injection nozzle 26b, and the lower injection nozzle 26c through the first and second supply pipes 28a and 28b by the pumping action of the washing pump 46 mounted at the sump 42, and a first preliminary washing (i.e., preliminary washing 1) is performed to inject the wash water to the dishes placed in the dish baskets 22 at high pressure in operation 204.

As the first preliminary washing (i.e., preliminary washing 1) progresses, in operation 206, the control unit 110 counts the progress time of the first preliminary washing to determine whether a predetermined preliminary washing time (i.e., approximately 15 minutes) has elapsed, i.e., the preliminary washing has been completed. When it is determined that the the preliminary washing has not been completed, the first preliminary washing is performed continuously Until the preliminary washing time elapses.

When it is determined that the preliminary washing has been completed, which means that the wash water and contaminants washed off the dishes by the wash water have been introduced into the sump 42, the turbidity sensor 44 mounted in the sump 42 senses light emitted from the light emitting part 44a, transmitted through the wash water used to wash the dishes, and received by the light receiving part 44b using the photo coupler to detect the turbidity V1 of the wash water used to wash the dishes during the first preliminary washing (i.e., preliminary washing 1) before the drainage of the wash water in operation 208.

The control unit 110 compares the turbidity V1 of the wash water detected by the turbidity sensor 44 with a predetermined reference turbidity (i.e., the turbidity of wash water to determine whether to progress from the preliminary washing) Va (operation 210). When the detected turbidity V1 of the wash water exceeds the predetermined reference turbidity Va, the control unit 110 determines that the contamination of the wash water is excessive, and drains the wash water containing the contaminants through the drainage pipe 50 according to an operation of the drainage pump 48 (operation 212).

The contaminants may be easily drained together with the wash water (contaminants having an intermediate specific gravity) or remain in the sump 42 after drainage (contaminants having a large or small specific gravity).

In order that the washing process is appropriately performed irrespective of kinds of contaminants, therefore, the turbidity of the wash water is detected before the drainage of the first preliminary washing and after the drainage and water supply for a second preliminary washing twice to determine whether to progress the second preliminary washing.

To this end, the control unit 110 controls the water supply valve 122 through the drive unit 120 to supply wash water necessary for the second preliminary washing (operation 214). As in the first preliminary washing (i.e., preliminary washing 1), the wash water supplied into the washing tub 20 is introduced into the sump 42. The introduced wash water is forwarded to the upper injection nozzle 26a, the middle injection nozzle 26b, and the lower injection nozzle 26c by the pumping action of the washing pump 46, and a second preliminary washing (i.e., preliminary washing 2) is performed to inject the wash water to the dishes placed in the dish baskets 22 at high pressure (operation 216).

When the second preliminary washing (i.e., preliminary washing 2) is performed, the control unit 110 determines whether a predetermined period of time (i.e., time necessary to detect the turbidity of wash water based on kinds of contaminants after the initiation of the washing) T (i.e., approximately 1 minute) has elapsed after the initiation of the second preliminary washing (operation 218). When the predetermined period of time T has not elapsed, the second preliminary washing is performed continuously until the predetermined period of time T elapses.

When it is determined that the predetermined period of time T has elapsed, which means that the wash water and contaminants washed off the dishes by the wash water have been introduced into the sump 42 for the predetermined period of time during the second preliminary washing, the turbidity sensor 44 detects the turbidity V2 of the wash water used to wash the dishes during the second preliminary washing (i.e., preliminary washing 2) (operation 220).

In FIG. 3B, the control unit 110 compares the turbidity V2 of the wash water detected by the turbidity sensor 44 with the predetermined reference turbidity Va (operation 222). When the detected turbidity V2 of the wash water exceeds the predetermined reference turbidity Va, the control unit 110 determines that the contamination of the wash water is excessive, and completely performs the second preliminary washing (i.e., preliminary washing 2) (operation 224).

As the second preliminary washing (i.e., preliminary washing 2) progresses, the control unit 110 counts the progress time of the second preliminary washing to determine whether the preliminary washing has been completed (operation 226). When the preliminary washing has not been completed, the second preliminary washing is performed continuously until the preliminary washing time elapses.

When it is determined that the preliminary washing has been completed, the control unit 110 drains the wash water containing the contaminants according to the operation of the drainage pump 48 (operation 228). After that, the control unit 110 controls the water supply valve 122 to supply wash water necessary for a main washing such that the main washing is performed after the preliminary washing (operation 230).

As in the first or second preliminary washing (i.e., preliminary washing 1 or 2), the wash water supplied into the washing tub 20 is introduced into the sump 42. The introduced wash water is forwarded to the upper injection nozzle 26a, the middle injection nozzle 26b, and the lower injection nozzle 26c by the pumping action of the washing pump 46, and a main washing is performed to inject the wash water to the dishes placed in the dish baskets 22 at high pressure (operation 232).

When it is determined at operation 222 that the detected turbidity V2 of the wash water does not exceed the predetermined reference turbidity Va, on the other hand, the control unit 110 determines that the contamination of the wash water is not excessive, and omits the second preliminary washing. Specifically, the control unit 110 changes the second preliminary washing into a main washing (operation 223). Consequently, the procedure advances to operation 232 to progress the main washing.

The main washing is an operation in which detergent is introduced into the wash water through a detergent introduction unit (not shown), while the wash water is heated to a predetermined temperature (i.e., approximately 60 to 65° C.) by the heater 30, before the washing water is injected at high pressure by the pumping action of the washing pump 46 such that hot wash water containing the detergent is injected to the dishes placed in the dish baskets 22 to wash the dishes.

As the main washing progresses, the control unit 110 counts the progress time of the main washing to determine whether a predetermined main washing time (i.e., approximately 15 minutes) has elapsed, i.e., the main washing has been completed (operation 234). When the main washing has not been completed, the main washing is performed continuously until the main washing time elapses.

When it is determined that the main washing has been completed, the turbidity V3 of the wash water used to wash the dishes during the main washing is detected before the drainage of the wash water (operation 236).

The control unit 110 compares the detected turbidity V3 of the wash water with a predetermined reference turbidity (the turbidity of wash water to determine whether to progress a preliminary rinsing) Vb (operation 238). When the detected turbidity V3 of the wash water exceeds the reference turbidity Vb, the control unit 110 determines that the contamination of the wash water is excessive, and drains the wash water containing the contaminants according to the operation of the drainage pump 48 (operation 240).

The contaminants may be easily drained together with the hot wash water (contaminants having an intermediate specific gravity) or remain in the sump 42 after drainage (contaminants having a large or small specific gravity).

In order that the rinsing process is appropriately performed irrespective of kinds of contaminants, therefore, the turbidity of the wash water is detected before the drainage of the main washing and after the drainage and water supply for a preliminary rinsing twice to determine whether to progress a first preliminary washing.

To this end, the control unit 110 controls the water supply valve 122 to supply wash water necessary for the first preliminary rinsing (operation 242). As in the preliminary or main washing, the wash water supplied into the washing tub 20 is introduced into the sump 42. The introduced wash water is forwarded to the upper injection nozzle 26a, the middle injection nozzle 26b, and the lower injection nozzle 26c by the pumping action of the washing pump 46, and a first preliminary rinsing (i.e., preliminary rinsing 1) is performed to inject the wash water to the dishes placed in the dish baskets 22 at high pressure (operation 244).

When the first preliminary rising (i.e., preliminary rinsing 1) is performed, the control unit 110 determines whether a predetermined period of time (i.e., time necessary to detect the turbidity of wash water based on kinds of contaminants after the initiation of the rinsing) T (i.e., approximately 1 minute) has elapsed after the initiation of the first preliminary rising (operation 246). When the predetermined period of time T has not elapsed, the first preliminary rinsing is performed continuously until the predetermined period of time T elapses.

When it is determined that the predetermined period of time T has elapsed in operation 246, which means that the wash water and contaminants washed off the dishes by the wash water have been introduced into the sump 42 for the predetermined period of time during the first preliminary rinsing, the turbidity sensor 44 detects the turbidity V4 of the wash water used to wash the dishes during the first preliminary rinsing (preliminary rinsing 1) (operation 248 of FIG. 3C).

The control unit 110 compares the detected turbidity V4 of the wash water with the predetermined reference turbidity Vb (operation 250). When the detected turbidity V4 of the wash water exceeds the predetermined reference turbidity Vb, the control unit 110 determines that the contamination of the wash water is excessive, and completely performs the first preliminary rinsing (i.e., preliminary rinsing 1) (operation 252).

As the first preliminary rinsing (i.e., preliminary rinsing 1) progresses, the control unit 110 counts the progress time of the first preliminary rinsing to determine whether the preliminary rinsing has been completed (operation 254). When the preliminary rinsing has not been completed, the first preliminary rinsing is performed continuously until the preliminary rinsing time elapses.

When it is determined that the preliminary rinsing has been completed, the control unit 110 drains the wash water containing the contaminants according to the operation of the drainage pump 48 (operation 256). After that, the control unit 110 controls the water supply valve 122 to supply wash water necessary for a second preliminary rinsing such that the second preliminary rinsing is performed after the first preliminary rinsing, and performs the second preliminary rinsing in the same manner as the first preliminary rinsing (operation 258).

After the preliminary rinsing is completed, and the wash water is drained, a final rinsing operation is performed (operation 260).

The final rinsing is an operation in which gloss detergent is introduced into the wash water through a detergent introduction unit (not shown), while the wash water is heated to a predetermined temperature (i.e., approximately 73 to 75° C.) by the heater 30, before the washing water is injected at high pressure by the pumping action of the washing pump 46 such that hot wash water containing the gloss detergent is injected to the dishes placed in the dish baskets 22 to wash the dishes. When the hot water heated to a temperature of approximately 73 to 75° C. is injected to the dishes, the dishes are heated, and then the dishes are dried by latent heat. Consequently, the final rinsing provides a drying effect.

When it is determined at operation 250 that the detected turbidity V4 of the wash water does not exceed the predetermined reference turbidity Vb, on the other hand, the control unit 110 determines that the contamination of the wash water is not excessive, and performs continuously the first preliminary rinsing (i.e., preliminary rinsing 1) with the omission of the second preliminary rinsing (operation 262).

As the first preliminary rinsing (i.e., preliminary rinsing 1) progresses, the control unit 110 counts the progress time of the first preliminary rinsing to determine whether the preliminary rinsing has been completed (operation 264). When the preliminary rinsing has not been completed, the first preliminary rinsing is performed continuously until the preliminary rinsing time elapses.

When it is determined that the preliminary rinsing has been completed, the control unit 110 drains the wash water containing the contaminants according to the operation of the drainage pump 48 (operation 266), and omits the second preliminary rinsing after the completion of the first preliminary rinsing. Consequently, the procedure advances to operation 260 to progress the final rinsing operation.

When it is determined at operation 212 that the detected turbidity V1 of the wash water does not exceed the predetermined reference turbidity Va, on the other hand, the control unit 110 determines that the contamination of the wash water is not excessive, and omits the second preliminary washing. Consequently, the process advances to operation 228 to drain the wash water and progress the main washing.

When it is determined at operation 238 that the detected turbidity V3 of the wash water does not exceed the predetermined reference turbidity Vb, the control unit 110 determines that the contamination of the wash water is not excessive, and drains the wash water with the omission of the preliminary rinsing (operation 239). After that, the process advances to operation 260 to progress the final rinsing operation.

In the above description, the turbidity V3 of the wash water before drainage of the main washing and the turbidity V4 of the wash water after the performance of the first preliminary rinsing (i.e., preliminary rinsing 1) for the predetermined period of time are detected twice, and, when the detected turbidities V3 and V4 of the wash water do not exceed the reference turbidity Vb, the second preliminary rinsing (i.e., preliminary rinsing 2) is omitted. However, the present invention is not limited to this construction. In the rinsing operation, the contamination of the wash water is relatively low with the result that the difference between the detected turbidities and the reference turbidity may be small. In order to prevent misdetermination due to the small difference, therefore, the present invention may be constructed such that, when it is determined that the contamination of the wash water is excessive based on the turbidity V1 of the wash water before drainage of the first preliminary washing and the turbidity V2 of the wash water after the performance of the second preliminary washing for the predetermined period of time, the second preliminary rinsing (i.e., preliminary rinsing 2) is unconditionally performed to reliably remove even CU-level contamination.

As apparent from the above description, the turbidity of wash water is detected during washing to decide a next washing operation. Consequently, the present invention has the effect of reducing the number of washing times and thus preventing waste of wash water.

Furthermore, the turbidity of wash water before drainage of a previous washing operation and the turbidity of wash water after the initiation of a next washing operation are detected twice to determine kinds of contamination such that a load action of the next washing operation can be changed to accomplish an appropriate washing process irrespective of kinds of contamination. Consequently, the present invention has the effect of appropriately controlling washing time.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A washing control method of a dish washing machine, comprising:
detecting a turbidity of wash water while performing washing using the wash water; and
determining a washing operation to be performed based on the detected turbidity of the wash water.

2. The washing control method according to claim 1, wherein detecting the turbidity of the wash water comprises:
detecting a turbidity of wash water before drainage of a previous washing operation and a turbidity of wash water after the initiation of a next washing operation.

3. The washing control method according to claim 2, wherein the turbidity of the wash water after the initiation of the next washing operation comprises a turbidity of wash water after the performance of the next washing operation for a predetermined period of time after water supply for the next washing operation.

4. The washing control method according to claim 2, wherein the previous washing operation is a first preliminary washing of the dish washing machine.

5. The washing control method according to claim 4, wherein the next washing operation is a second preliminary washing of the dish washing machine.

6. The washing control method according to claim 2, wherein the previous washing operation is a main washing of the dish washing machine.

7. The washing control method according to claim 6, wherein the next washing operation is a preliminary rinsing of the dish washing machine.

8. The washing control method according to claim 2, wherein determining the washing operation to be performed comprises:
comparing the detected turbidity of the wash water with a predetermined reference turbidity, and, when the detected turbidity of the wash water does not exceed the predetermined reference turbidity, omitting at least one washing operation from a predetermined series of washing operations.

9. The washing control method according to claim 8, wherein omitting the at least one washing operation comprises:
omitting a preliminary washing or a preliminary rinsing of the dish washing machine.

10. The washing control method according to claim 8, wherein determining the washing operation to be performed further comprises:
when the detected turbidity of the wash water does not exceed the predetermined reference turbidity, changing the washing operation in progress into a subsequent operation.

11. The washing control method according to claim 10, wherein changing the washing operation in progress into the subsequent operation comprises:
changing the second preliminary washing in progress into a main washing.

12. The washing control method according to claim 8, wherein determining the washing operation to be performed further comprises:
when the detected turbidity of the wash water exceeds the predetermined reference turbidity, completely performing the predetermined series of washing operations.

13. A washing control apparatus of a dish washing machine, comprising:
a turbidity detection unit to detect a turbidity of wash water while washing is performed using the wash water; and
a control unit to determine a washing operation based on the detected turbidity of the wash water.

14. The washing control apparatus according to claim 13, wherein the turbidity detection unit detects a turbidity of wash water before drainage of a previous washing operation and a turbidity of wash water after the initiation of a next washing operation.

15. The washing control apparatus according to claim 13, wherein the control unit compares the detected turbidity of the wash water with a predetermined reference turbidity, and, when the detected turbidity of the wash water does not exceed the predetermined reference turbidity, omits a preliminary washing or a preliminary rinsing from a predetermined series of washing operations.

16. The washing control apparatus according to claim 15, wherein, when the detected turbidity of the wash water does not exceed the predetermined reference turbidity, the control unit changes a second preliminary washing in progress into a main washing.

17. The washing control apparatus according to claim 15, wherein, when the detected turbidity of the wash water exceeds the predetermined reference turbidity, the control unit completely performs the predetermined series of washing operations.

18. A washing control apparatus of a dish washing machine, comprising:
a control unit to control the dish washing machine and to detect a turbidity of wash water before drainage of a previous washing operation.

19. The washing control apparatus of claim 18, wherein the control unit detects a first turbidity of wash water before draining of a first preliminary washing operation and a second turbidity of wash water after water supply for a second preliminary washing operation.

20. The washing control apparatus of claim 19, wherein when the control unit determines that the detected first and second turbidities of the wash water exceed a predetermined reference turbidity, the control unit determines that contamination of the wash water is excessive, and proceeds with performance of the second preliminary washing operation.

21. The washing control apparatus of claim 19, wherein when the control unit determines that the detected first and second turbidities of the wash water do not exceed a predetermined reference turbidity, the control unit changes the second preliminary washing operation into a main washing operation.

22. The washing control apparatus of claim 19, wherein the control unit detects a third turbidity of wash water before drainage of the main washing operation, and a fourth turbidity of was water after water supply for a first preliminary rinsing operation, wherein:
when the detected third and fourth turbidities of the wash water exceed a predetermined reference turbidity, the control unit determines that contamination of the wash water is excessive, and proceeds with performance of a second preliminary rinsing operation, and
when the detected third and fourth turbidities of the wash water do not exceed the predetermined reference turbidity, the control unit omits the second preliminary rinsing operation.
